(19) United States
(12) Patent Application Publication
(10) Pub. No.: US 2011/0261253 A1
(43) Pub. Date: Oct. 27, 2011

(54) CAMERA MODULE

(75) Inventor: JEN-TSORNG CHANG, Tu-Cheng (TW)

(73) Assignee: HON HAI PRECISION INDUSTRY CO., LTD., Tu-Cheng (TW)

(21) Appl. No.: 12/956,214

(22) Filed: Nov. 30, 2010

(30) Foreign Application Priority Data
Apr. 26, 2010 (CN) 201010155722.6

(51) Int. Cl. H04N 5/225

(52) U.S. Cl. 348/374; 348/E05.024

(57) ABSTRACT

A camera module includes a holder, a barrel, an image sensor module, and a printed circuit board. The barrel receives lenses. The barrel is received in the holder. The image sensor module includes a substrate and an image sensor. The substrate is positioned at one side of the holder. The image sensor is mounted on the substrate and aligned with the lenses. First solder pads are positioned in the substrate. The first solder pads are electrically coupled to the image sensor. The printed circuit board includes second solder pads. The second solder pads are electrically coupled to the first solder pads. The printed circuit board is positioned at an exterior surface of the holder.

### BACKGROUND

1. Technical Field

The disclosure relates to camera modules, and particularly to a camera module having a small thickness.

2. Description of the Related Art

Generally, a thickness of a camera module is dependent on combined thickness of a lens module, an image sensor and a printed circuit board. It is a priority to reduce the thickness of the camera module. Therefore, there is a need for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a cross-section of a camera module in accordance with a first embodiment of the disclosure, the camera module including an image sensor module.

FIG. 2 is a top view of the image sensor module of the camera module in FIG. 1.

FIG. 3 is a cross-section of a camera module in accordance with a second embodiment of the disclosure, the camera module including an image sensor module.

FIG. 4 is a top view of the image sensor module of the camera module in FIG. 3.

### DETAILED DESCRIPTION

The disclosure is illustrated by way of example and not by way of limitation in the figures of the accompanying drawings. It should be noted that references to “an” or “one” embodiment in this disclosure are not necessarily to the same embodiment, and such references mean at least one.

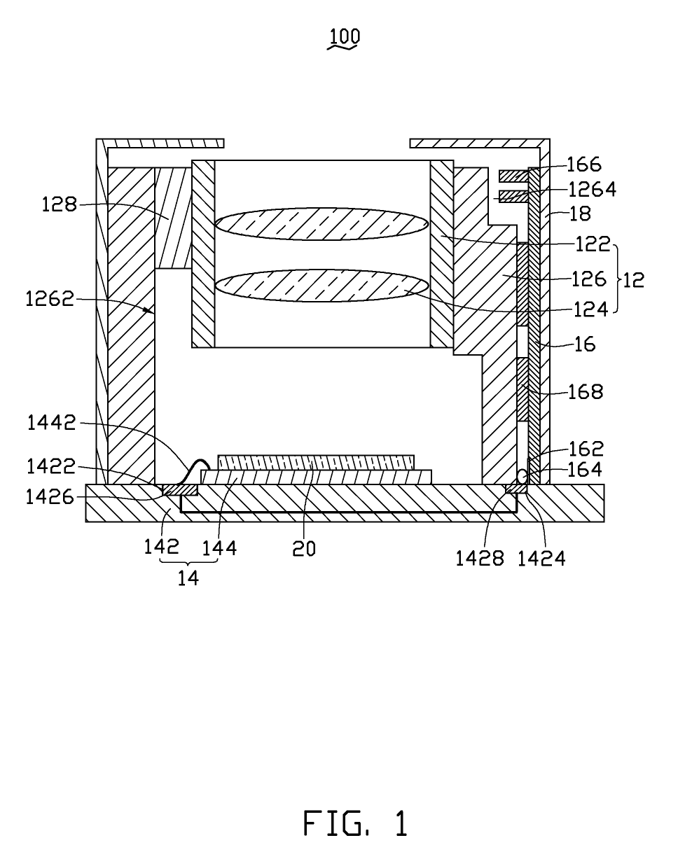

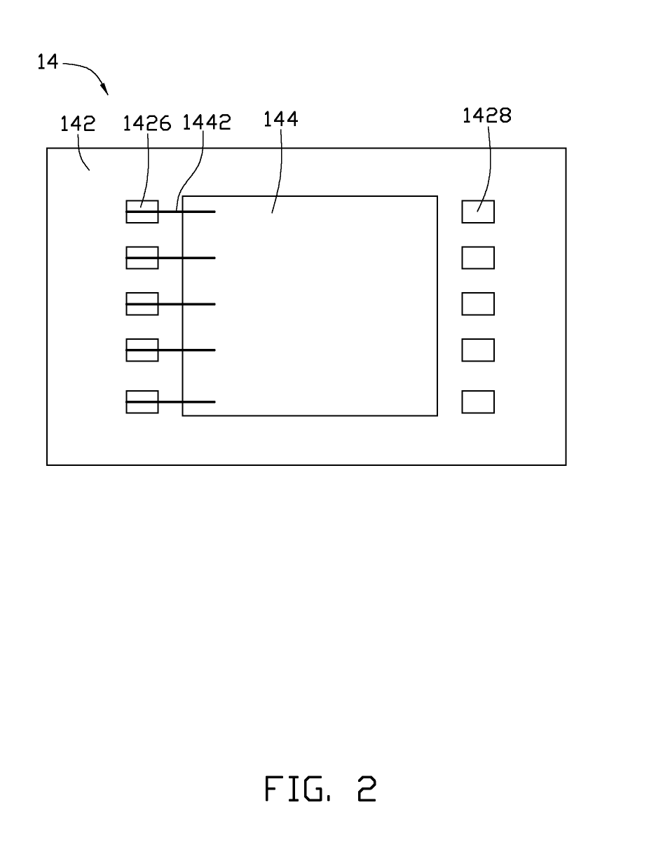

Referring to FIGS. 1-2, a camera module 100 in accordance with a first embodiment of the disclosure includes a lens module 12, an image sensor module 14, a printed circuit board (PCB) 15 and an electromagnetic shielding case 18.

The lens module 12 includes a barrel 122, a plurality of lenses 124 and a holder 126. The lenses 124 are received in the barrel 122.

An actuator 128 is fixed on an interior surface 1262 of the holder 126. The barrel 122 is received in the holder 126 and electrically coupled to the actuator 128. The actuator 128 directs the barrel 126 to move an axis of the holder 122. The actuator 128 can be a voice coil motor or a step motor.

The image sensor module 14 includes a substrate 142 and an image sensor 144 mounted on the substrate 142. The substrate 142 is fixed at one side of the holder 126. The image sensor 144 is neighboring to the barrel 122. The substrate 142 can be ceramic, metal, epoxy or a combination thereof. In the first embodiment, the camera module 100 further includes an infrared filter (IR filter) 20. The IR filer 20 is defined on a surface of the image sensor 144. The IR filter 20 filters infrared light from environmental light to increase photo performance. The IR filter 20 also can be defined in the barrel 122.

The image sensor 144 includes a plurality of leads 1442. A plurality of first blind holes 1422 and a plurality of second blind holes 1424 are defined in the substrate 142. A plurality of first solder pads 1426 is defined in the first blind holes 1422. A plurality of second solder pads 1428 is defined in the second blind holes 1424. The first solder pads 1426 are electrically coupled to the second solder pads 1428 through a plurality of lines defined in the substrate 142. The leads 1442 are electrically coupled to the first solder pads 1426. The first blind holes 1422 and the second blind holes 1424 also can be through holes.

The PCB 16 is defined at an exterior surface of the holder 126. One side of the PCB 16 is neighboring to the second solder pads 1428. The PCB 16 is fixed on the exterior surface of the holder 126 through adhesives 168. The PCB includes a plurality of third solder pads 162. The third solder pads 162 are electrically coupled to the second solder pads 1428 through conductive adhesive 164. A plurality of passive electronic components is mounted on the PCB 16, a slot 1264 is defined in the exterior surface of the holder 126 for receiving passive electronic components.

The electromagnetic shielding case 18 receives the holder 126 and the PCB 16. The electromagnetic shielding case 18 is configured for shielding the electromagnetic interference from other electronic devices.

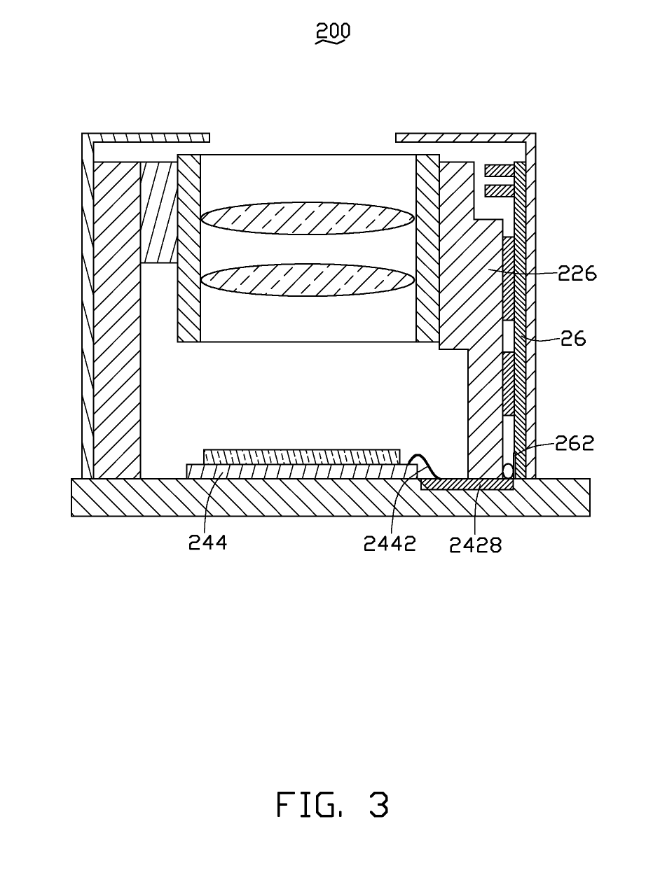

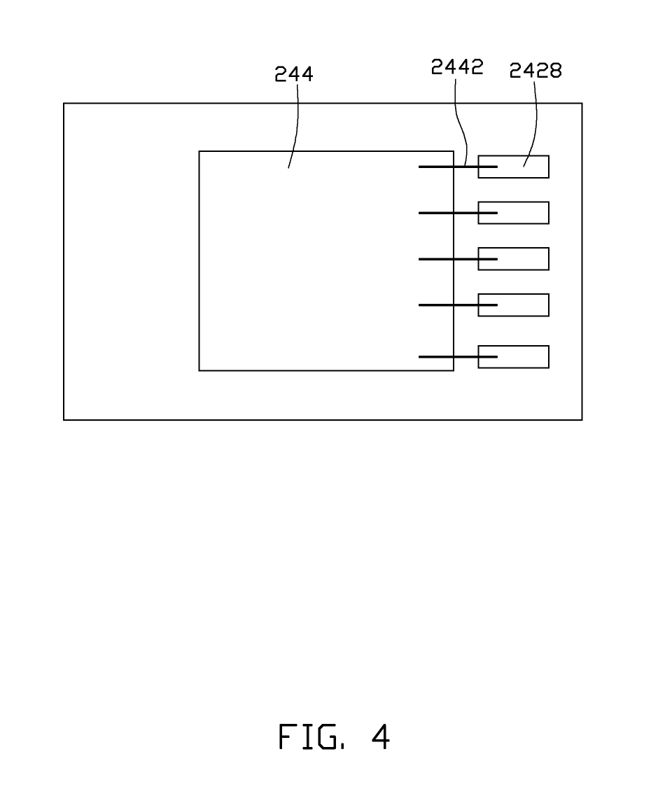

Referring to FIGS. 3-4, a camera module 200 in accordance with a second embodiment of the disclosure is similar to the camera module 100 of the first embodiment, differing only in that the camera module 200 only includes a plurality of second solder pads 2428. The second solder pads 2428 are extended to exceed the fringe of the holder 226. The leads 2442 of the image sensor 244 are electrically coupled to the third solder pads 262 of the PCB 26 through the second solder pads 2428.

While the disclosure has been described by way of example and in terms of exemplary embodiment, it is to be understood that the disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A camera module comprising:
a holder defining a first opening and a second opening;
a barrel receiving a plurality of lenses, the barrel received in the holder, the barrel being positioned near the first opening;
an image sensor module comprising a substrate and an image sensor, the substrate positioned near the second opening, the image sensor mounted on the substrate and aligned with the lenses, a plurality of first solder pads defined on the substrate, the first solder pads electrically coupled to the image sensor; and
a printed circuit board positioned on an exterior surface of the holder and comprising a plurality of second solder pads, the second solder pads electrically coupled to the first solder pads.

2. The camera module of claim 1, wherein the first solder pads exceed a fringe of the holder, the image sensor comprises a plurality of leads electrically coupled to the first solder pads correspondingly.

3. The camera module of claim 1, wherein a plurality of third solder pads is defined in the substrate, the image sensor comprises a plurality of leads electrically coupled to the third solder pads correspondingly, the first solder pads are electrically coupled to the image sensor through the third solder pads and the leads.

4. The camera module of claim 3, wherein a plurality of blind holes is defined in the substrate, the first solder pads and the third solder pads are defined in the blind holes.

5. The camera module of claim 3, wherein a plurality of through holes is defined in the substrate, the first solder pads and the third solder pads are defined in the through holes.

6. The camera module of claim 1, wherein a slot is defined in the exterior surface of the holder and configured for receiving a plurality of passive electronic components mounted on the printed circuit board.

7. The camera module of claim 1, further comprising an electromagnetic shielding case receiving the holder and the printed circuit board.

8. The camera module of claim 1, wherein the first solder pads is electrically coupled to the second solder pads through conductive adhesive.

9. A camera module comprising:
a holder receiving a barrel, the barrel receiving a plurality of lenses;
an image sensor module aligned with the lenses and configured for receiving light from the lenses; and
a printed circuit board positioned at an exterior surface of the holder, the printed circuit board electrically coupled to the image sensor module.

10. The camera module of claim 9, wherein the image sensor module comprises a plurality of first solder pads.

11. The camera module of claim 10, wherein the printed circuit board comprises a plurality of second solder pads electrically coupled to the first solder pads of the image sensor module.

12. The camera module of claim 9, further comprising an electromagnetic shielding case receiving the holder, and the printed circuit board.
